(19) United States
(12) Patent Application Publication
(10) Pub. No.: US 2006/0175109 A1
(43) Pub. Date: Aug. 10, 2006

(54) Motorcycle with front side wheels

(76) Inventor: Chih-Hung Cheng, Kaohsiung (TW)

Correspondence Address: LEONG C LEI, PMB # 1008, 1867 YGNACIO VALLEY ROAD, WALNUT CREEK, CA, 94598, US

(21) Appl. No.: 11/047,584

(22) Filed: Feb. 2, 2005

(51) Int. Cl. B62K 11/00

(52) U.S. Cl. 180/219; 280/293

(57) ABSTRACT

A pair of side wheels mounted to the front wheel of a motorcycle includes front base frame, steering unit comprised of linkage and steering rod set being pivoted to the center of the base frame, two side suspensions, and two side wheels; a pair of connection rods of the linkage unit each respectively pivoted to the base of the side wheel unit; a regulator from the suspension unit being connected to where between the base and the base frame, and further to head tube of the frame through an absorber; and the base being pivoted to the side wheel to improve riding safety and stability.

### BACKGROUND OF THE INVENTION

(a) Technical Field of the Invention

The present invention is related to an improved construction of a motorcycle, and more particularly, to one provided with a pair of side wheels each on both sides of the front wheel.

(b) Description of the Prior Art

The motorcycle is a very important transportation means particularly in countries under development. It is used for commuting, delivering and picking up children to and from school, and even for delivering goods. It however presents potential risks to the safety of the riders. After all, a two-wheel motorcycle is nothing comparable to an automobile either in riding safety, stability, or comfort. The rider of a motorcycle has to support it with one foot holding fast to the ground while waiting for the green light or in case of a traffic jam. Nonetheless, the agile mobility of the motorcycle is the only reason its survival depends on. To improve its riding safety and stability, this inventor disclosed innovative side wheels each mounted to both sides of the front wheel as published in ROC (Taiwan) Gazette (Patent Application Nos. 534046 and 534056).

### SUMMARY OF THE INVENTION

The primary purpose of the present invention is to provide an improved construction for the motorcycle which, adapted to its front wheels are a pair of side wheels for further increasing the riding safety and stability of the motorcycle. To achieve the purpose, a pair of side wheels respectively mounted to both sides of the front wheel of the motorcycle is essentially comprised of a base frame, a steering, two side suspensions, and two side wheels. Wherein, a linkage and a steering rod of the steering are pivoted to the center of the base frame. Two connection rods from the steering are each pivoted to its corresponding base of the side wheel. A regulator of the suspension is connected to where between the front base frame and the base of the side wheel, and further to an absorber and the frame of the motorcycle. The base of the side wheel is pivoted to the side wheel.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a side view of a preferred embodiment of the present invention.

FIG. 2 is a from perspective view of the preferred embodiment of the present invention.

FIG. 3 is a rear perspective view of the preferred embodiment of the present invention.

FIG. 4 is a front view of the preferred embodiment of the present invention.

FIG. 5 is a schematic view showing the operation of a side suspension unit of the preferred embodiment of the present invention.

FIG. 6 is a bird's view showing the operation of the steering unit of the preferred embodiment of the present invention.

FIG. 7 is another bird's view showing the operation of the steering unit of the preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

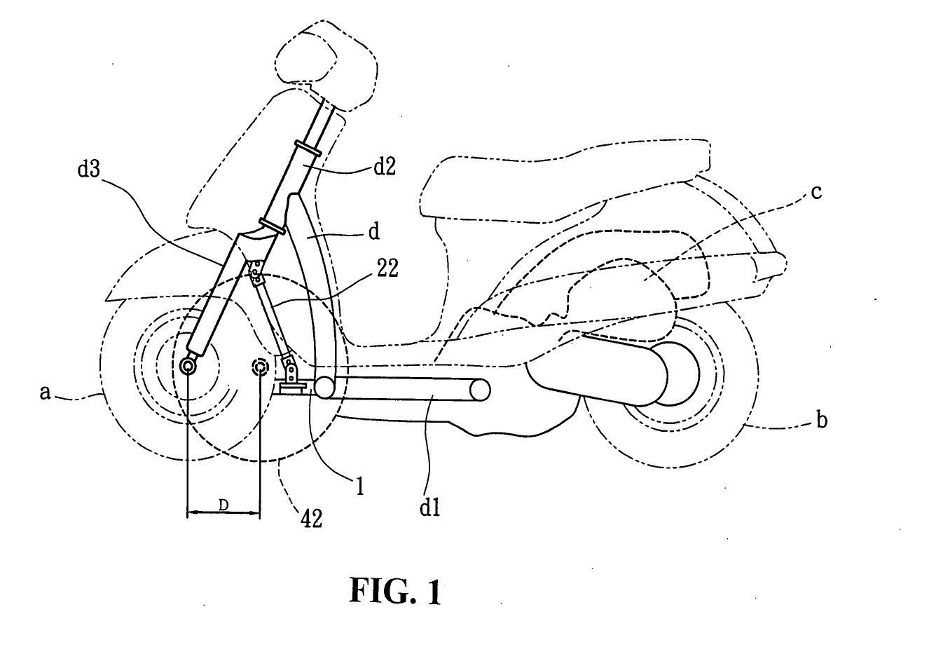

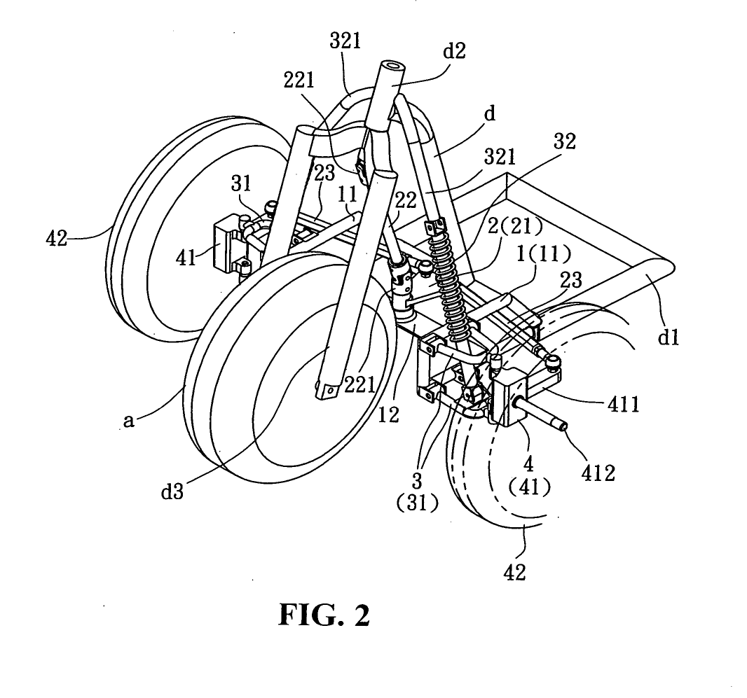

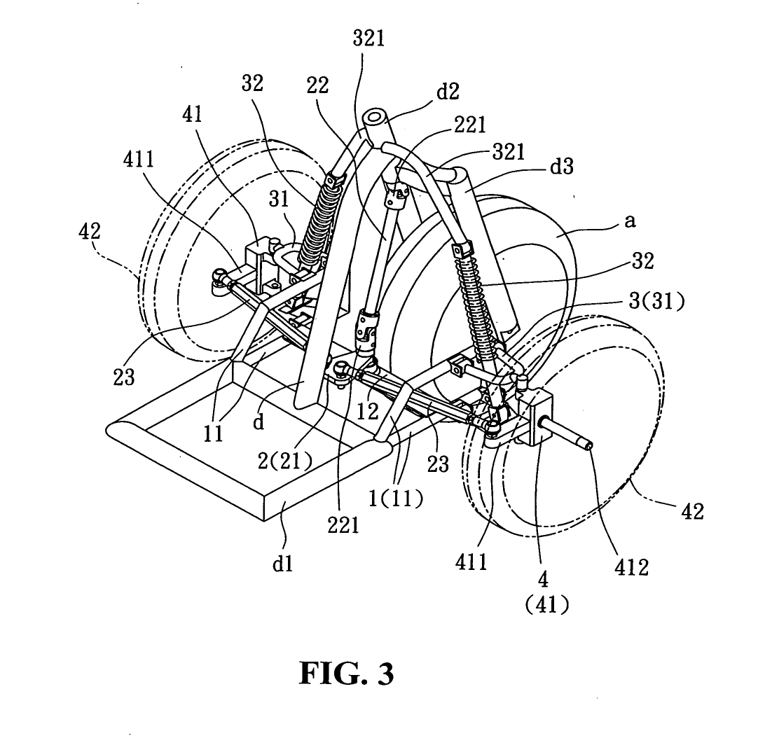

Referring to FIG. 1, an improved construction of a motorcycle adapted with two side wheels respectively to both sides of the front wheel is essentially comprised of a front wheel a, a rear wheel b, a power unit c (e.g., an engine or a motor), and a frame d. A head tube d2 is disposed at the front of a chassis d1 of the frame d also as illustrated in FIGS. 2 and 3. The head tube d2 is pivoted to the front wheel with a fork d3. A front base frame 1, a steering linkage unit 2, two suspensions 3, and two side wheel units 4 are provided to the existing frame d of the motorcycle.

As illustrated in FIGS. 2 and 3, the front base frame 1 connected to where in front of the chassis d1 of the frame d includes two side tubes 11 and a connection tube 12.

The steering linkage unit 2 includes a linkage 21, a steering rod 22 and a pair of connection rods 23. The linkage 21 is pivoted to the connection tube 12 of the front base frame 1 and upwards pivoted to the steering rod 22. Two universal joints 221 are respectively disposed to the upper and the lower ends of the steering rod 22. The upper universal joint 221 is connected to the head tube d2 of the frame d, and the lower universal joint 221 is connected to the linkage 21. The inner ends of both of connection rods 23 are connected to the linkage 21.

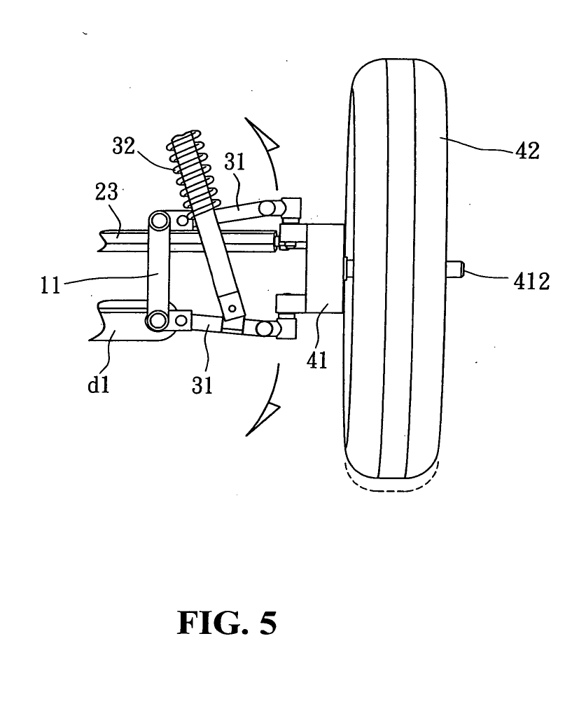

The side suspension 3 as illustrated in FIGS. 2, 3, and 4 includes two regulators 31 and an absorber 32. As illustrated in FIG. 5, inner ends of both regulators 31 are pivoted to the side tube 11 for the regulators 31 to oscillate with their inner ends as a support. The bottom of the absorber 32 is connected to the lower regulator 31, and the top of the absorber 32 is connected to the head tube d2 of the frame d so that when the absorber 32 is retracting, both regulators 31 oscillate with their inner ends as the support.

Referring to FIGS. 2 and 3, each side-wheel unit 4 includes a base 41 and a side wheel 42. The base 41 is connected to the outer end of the regulator 31 and pivoted to the outer end of the connection rod 23. An arm 411 extends from the rear of the base 41 for the outer end of the connection rod to be pivoted to the extension arm 411 while a shaft 412 is disposed on the outer side of the base for the side wheel 42 to be pivoted to the shaft 412.

As indicated by the test results, the distance, D, between the axis of the side wheel 42 and that of the front wheel a is preferred ranging from 0-48 cm.

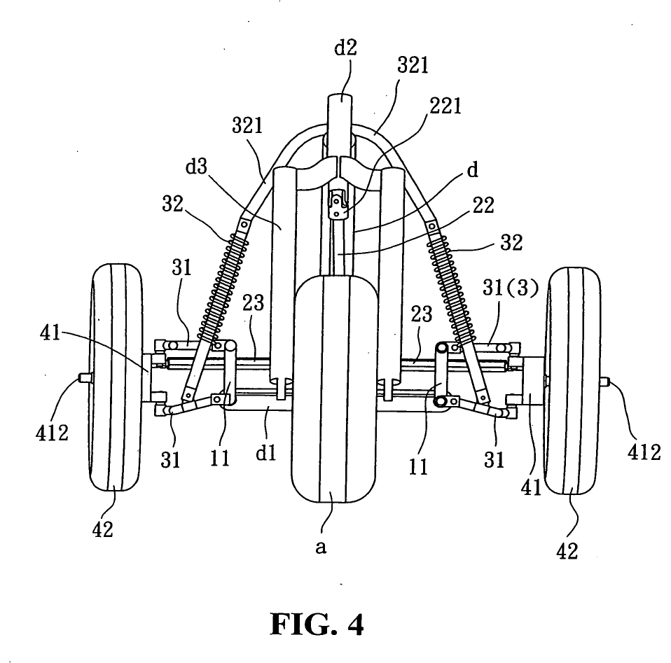

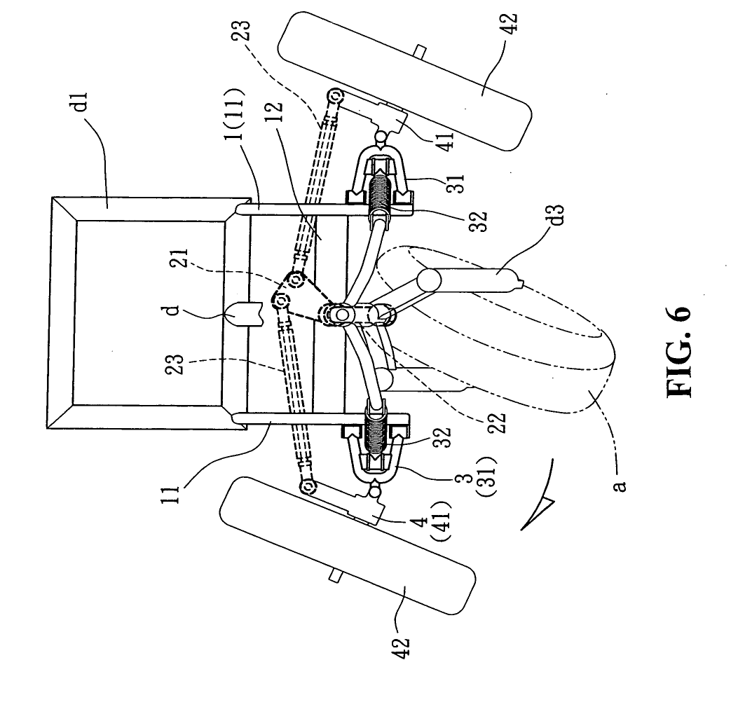

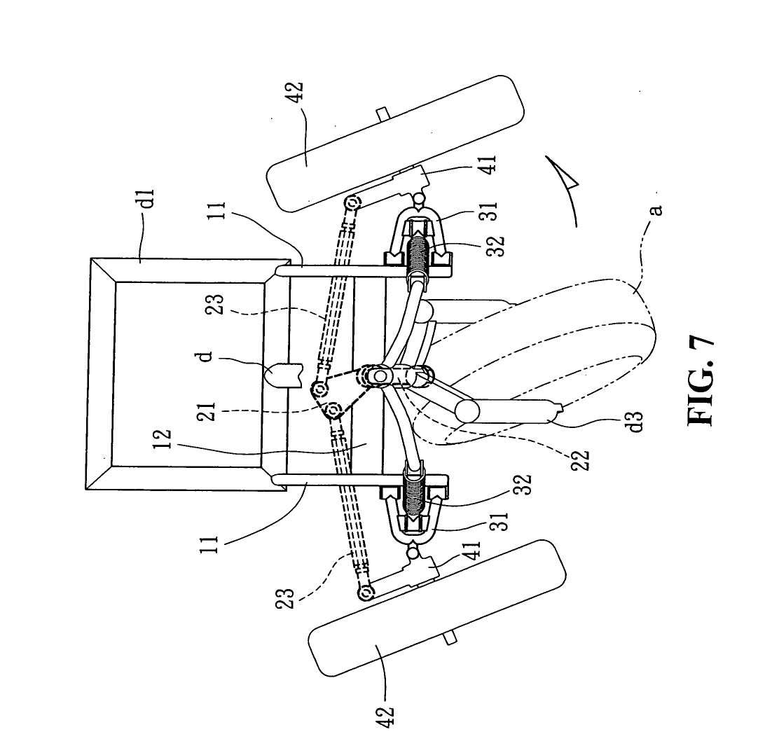

Now referring to FIGS. 4 through 7, when the motorcycle drives straight ahead, both side wheels 42 help stabilize the moving motorcycle as illustrated in FIGS. 4 and 5 while both suspensions 3 are regulated depending on the road conditions to promote the stable riding. When the motorcycle is taking turns as illustrated in FIGS. 6 and 7, the side wheels 42 and the front wheel a take the turn synchronously, the linkage 21 and the connection rod 23 of the steering linkage unit 2 respectively oscillate and operate at the same time.

Meanwhile the steering rod 22 changes its angle and the base 41 of the side-wheel unit 4 turns its direction due to that by the side wheel 42. As pulled and controlled by the connection rod 23, the base 41 of the side-wheel unit 4 achieves its linked turning purpose. Furthermore, the absorber 32 of the suspension unit 3 retracts towards the turning direction or extends towards the direction opposite to the turning direction. The regulator 31 also swings with its inner end as the support. Accordingly, the improved construction of the present invention increases safe and stable ride of the motorcycle.

The present invention gives the following progresses essentially by providing a side wheel 42 to each side of the front wheel a:
1. Both side wheels 42 improve riding safety, comfort, and stability. It won't be necessarily for the rider to put his one foot or both feet against the ground while waiting for the green light or in case of a traffic jam.
2. The size of the present invention is compact to prevent from affecting the good mobility of the motorcycle and taking additional parking space. In addition, it helps saving fuel, thus money.

The present invention may be adapted to police patrol motorcycle to warrant safety while pursuing the suspect. In addition, it allows easy parking for the police on duty.

The present invention provides a substitute for an automobile to save money since the motorcycle is subject to much lower tax rate and consumes much less fuel while maintaining the safe and stable riding on the road as the automobile provides.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved construction of a motorcycle includes a motorcycle comprised of a front wheel, a rear wheel, a power unit and a frame; a head tube being disposed to the front of a chassis of the frame; the head tube being pivoted to the front wheel with a fork; the frame being further provided with a front base frame, a steering linkage unit, two side suspension units, and two side wheel units; wherein,
the front base frame being connected to the front of the chassis of the frame and including two side tubes and a connection tube;
the steering linkage unit including a linkage, a steering rod and a pair of connection rods; the linkage being pivoted to the connection from of the front base frame and upwards pivoted to the steering rod; the upper part of the steering rod being connected to the head tube of the frame and the lower part, to the linkage; and the inner end of the connection rod being connected also to the linkage;
the side suspension unit including two regulators and an absorber, the inner side of the regulator being pivoted to the side tube of the front base frame for the regulator to oscillate with its inner end as the support; the bottom of the absorber being connected to the regulator; and the top of the absorber being connected to the head tube of the frame; and
the side-wheel unit including a base and a side wheel; the outer end of the regulator being connected to and the outer end of the connection rod being pivoted to the base; the side wheel being pivoted to the base with a shaft disposed externally to the base.

2. The improved construction of a motorcycle of claim 1, wherein, the distance between the axis of the side wheel and that of the front wheel is preferred ranging from 0-48 cm.

3. The improved construction of a motorcycle of claim 1, wherein, the upper end and the lower end of the steering rod are each disposed with a universal joint.

4. The improved construction of a motorcycle of claim 1, wherein, the regulating unit includes an upper regulator and a lower regulator while the bottom of the absorber is connected to the lower regulator.

5. The improved construction of a motorcycle of claim 1, wherein, the top of the absorber is connected to the frame of the motorcycle.

6. The improved construction of a motorcycle of claim 1, wherein, an arm extending from the rear of the base for the outer end of the connection rod to be pivoted to the base.
